(19) United States
(12) Patent Application Publication
(10) Pub. No.: US 2009/0246748 A1
(43) Pub. Date: Oct. 1, 2009

(54) Device and method for teaching the concept of elapsed time

(76) Inventor: Anthony C. Williams, Columbia, SC (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/078,558

(22) Filed: Apr. 1, 2008

(51) Int. Cl. G09B 19/12

(52) U.S. Cl. 434/304

(57) ABSTRACT

The device for teaching the concept of elapsed time is an educational tool for teaching children the concept elapsed time, and how to understand the passage of time, with emphasis on particular time intervals, such as hourly intervals or portions of the day, and activities associated therewith. The device includes an elongated strip having longitudinally opposed first and second ends. The elongated strip further has opposed front and rear surfaces, and a first set of graduated demarcations is formed on the front surface. A first set of indicia are formed on the front surface adjacent the first set of graduated demarcations, with the first set of demarcations and the first set of indicia representing hours of the day. The first set of indicia represents the hours in the form of “1:00 P.M.” or “12:00 A.M”, for example. The first and second ends are preferably joined together to form a loop.

### BACKGROUND OF THE INVENTION

1. Field of the Invention

The present invention relates to a device and method for teaching the concept of elapsed time. Particularly, the device is an educational tool for teaching children the concept of time and how to understand the passage of time, with specific emphasis on particular time intervals, such as hourly intervals or portions of the day.

2. Description of the Related Art

The concept of elapsed time (i.e., the number of hours and minutes between two times of day and also the division of the day into differing periods of activity) is often difficult to teach to children. This concept may be especially difficult when a child uses an analog clock. In order to teach this concept, teachers often employ teaching aids in the form of teaching clocks. Such teaching clocks have the hour hand, minute hand and a face with numbered hours of a conventional analog clock, but not the clockwork mechanism to move the hands. Typically, a teacher positions the hands of such a teaching clock at a first selected time of day, which is noted by students. The teacher then positions the hands of the teaching clock at a second selected time of day and the students are asked to determine the time interval between the first and second times.

Such teaching devices may be adequate for teaching the differing times and numbers associated therewith, and for teaching a child how to read a clock face, but teaching clocks do not provide instruction or illustration of the division of the day into morning, afternoon or evening, for example. Such clocks and teaching methods further do not provide instruction into the actual meaning of an elapsed time period, and do not illustrate real-world activities with each hour or time period (for example, eating breakfast between 7:00 A.M. and 8:00 A.M., and then taking a school bus to school). It would be desirable to provide a tool and method for instructing children as to the real-world meaning of time and time intervals, rather than providing the numbers on a clock face as an abstract concept.

Thus, a device and method for teaching the concept of elapsed time solving the aforementioned problems is desired.

### SUMMARY OF THE INVENTION

The device for teaching the concept of elapsed time is an educational tool for teaching children the concepts of time and elapsed time, and how to understand the passage of time, with specific emphasis on particular time intervals, such as hourly intervals or portions of the day. The device includes an elongated strip which may be formed from paper, paperboard, cardboard or the like, having longitudinally opposed first and second ends. The elongated strip further has opposed front and rear surfaces, and a first set of graduated demarcations are formed on the front surface, in a manner similar to the length indicating lines formed on a ruler.

A first set of indicia are formed on the front surface adjacent the first set of graduated demarcations, with the first set of graduated demarcations and the first set of indicia representing hours of the day. The first set of indicia represents the hours in the form of “1:00 P.M.” or “12:00 A.M”, for example. The first set of graduated demarcations preferably each have a first length associated therewith.

Additionally, a second set of graduated demarcations are formed on the front surface, along with a second set of indicia, with the second set of graduated demarcations and the second set of indicia representing minutes within each hour of the day. The second set of demarcations has a second length associated therewith, which is preferably shorter than the first length. Thus, the demarcations are formed in a manner similar to a ruler, with the longest demarcations representing hours (and the shorter demarcations representing minutes.

A third set of indicia is further formed on the front surface, with the third set of indicia including a plurality of sub-sets of indicia, with each sub-set of indicia represents a portion of the day, such as morning, afternoon or evening. Preferably, each sub-set of indicia has a unique hue associated therewith.

A fourth set of indicia is additionally formed on the front surface, with the fourth set of indicia representing a plurality of activities associated with the hours of the day. The longitudinally opposed first and second ends are preferably joined together to form a loop, such that antemeridian and postmeridian hours are positioned diametrically opposite from one another.

These and other features of the present invention will become readily apparent upon further review of the following specification and drawings.

### BRIEF DESCRIPTION OF THE DRAWINGS

FIG. 1 is a perspective view of a device for teaching the concept of elapsed time according to the present invention.

FIG. 2 is a partial plan view of the device for teaching the concept of elapsed time according to the present invention.

FIG. 3 is a plan view of the device for teaching the concept of elapsed time according to the present invention.

Similar reference characters denote corresponding features consistently throughout the attached drawings.

### DETAILED DESCRIPTION OF THE PREFERRED EMBODIMENTS

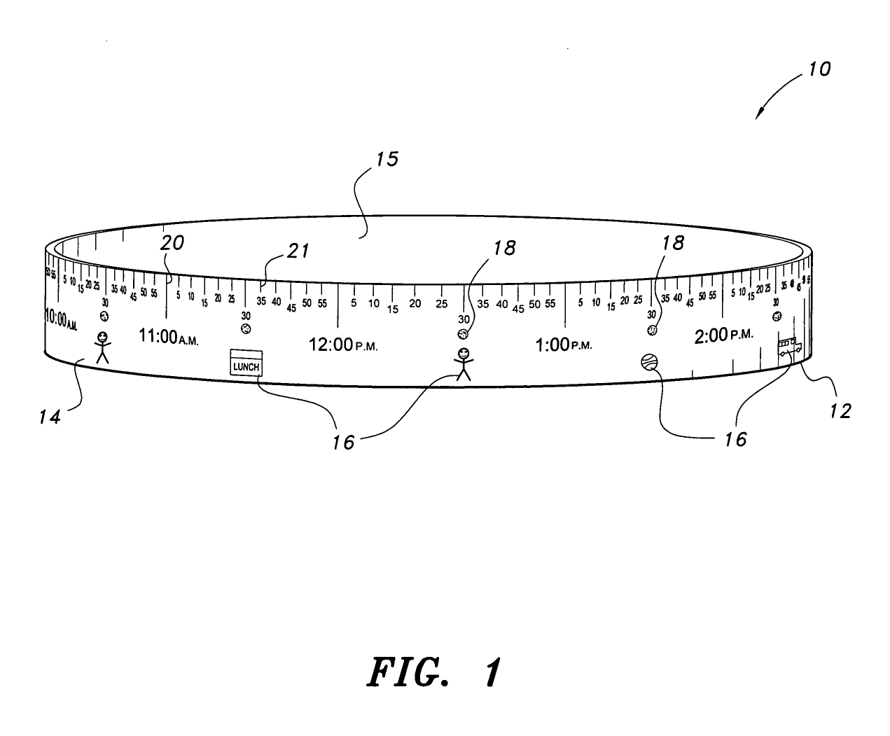

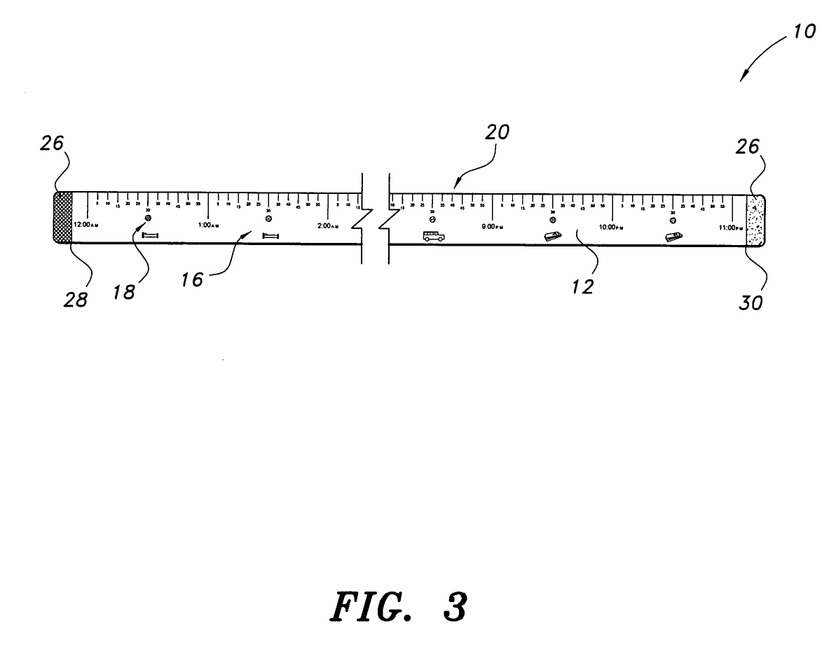

The present invention is directed towards a device and method for teaching the concept of elapsed time. As best shown in FIG. 1, the device 10 is an educational tool for teaching children the concept of time and elapsed time, and how to understand the passage of time, with specific emphasis on particular time intervals, such as hourly intervals or portions of the day. The device 10 includes an elongated strip 12 which may be formed from paper, paperboard, cardboard or the like, having longitudinally opposed first and second ends 28, 30 (shown in FIG. 3). As will be described in greater detail below, the first and second ends 28, 30 of strip 12 are preferably joined together to form the loop shown in FIG. 1. The elongated strip 12 further has opposed front and rear surfaces 14, 15, respectively, and a first set of graduated demarcations 20 are formed on the front surface 14, in a manner similar to the length indicating lines formed on a ruler.

A first set of indicia 24 are formed on the front surface adjacent the first set of graduated demarcations 20, with the first set of graduated demarcations 20 and the first set of indicia 24 representing hours of the day. The first set of indicia 24 represent the hours in the printed form of “1:00 P.M.” or “12:00 A.M”, for example. The indicia and demarcations may be formed or imprinted on the strip 12 through the use of any suitable marking, printing or other imprintation process. The first set of graduated demarcations 20 preferably each have a first length associated therewith. The first set of indicia are preferably provided to denote a twenty-four hour day, with both A.M. and P.M. time, though a twenty-four hour time system (such as that associated with military time in the United States, for example) may also be utilized.

Additionally, a second set of graduated demarcations 21 are formed on the front surface 14, along with a second set of indicia 22, with the second set of graduated demarcations 21 and the second set of indicia 22 representing minutes within each hour of the day. The second set of demarcations 21 have a second length associated therewith, which is preferably shorter than the first length. Thus, the demarcations 20, 21 are formed in a manner similar to a conventional ruler, with the longest demarcations representing hours (corresponding to inches or centimeters on a conventional ruler) and the shorter demarcations representing minutes (corresponding to the fractions of inches or centimeters on the conventional ruler). The second set of indicia 22 are preferably formed as “5”, “10”, “15”, “20”, “25”, “30”, “35”, “40”, “45”, “50”, and “55”, corresponding to the standard divisions on a clock and may be formed through the use of any suitable marking, printing or other imprintation process.

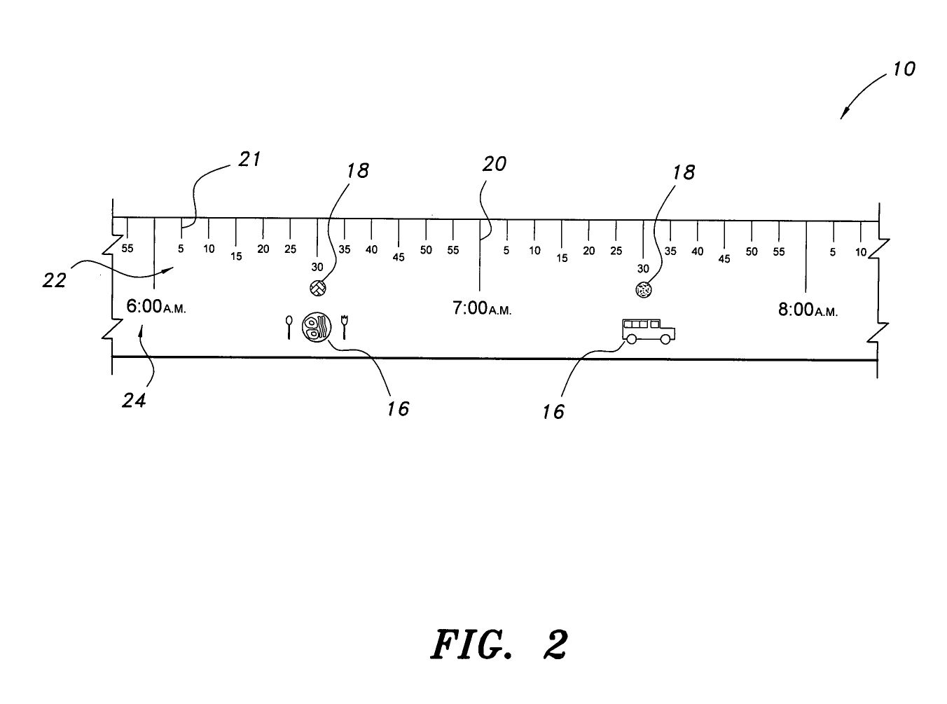

A third set of indicia 18 is further formed on the front surface 14, with the third set of indicia 18 including a plurality of sub-sets of indicia, with each sub-set of indicia representing a portion of the day, such as morning, afternoon or evening. Preferably, each sub-set of indicia has a unique hue associated therewith (shown as differing shades of gray in FIG. 2). For example, each of the indicia 18 may be a circle (as shown in the examples of FIGS. 1-3) or another geometric form, and the circles between 12:00 P.M. and 6:00 P.M. may be orange, representing the “afternoon” division of the day, and the circles between 6:00 P.M. and 6:00 A.M. may be red, representing the “evening” portion of the day.

A fourth set of indicia 16 are additionally formed on the front surface 14, with the fourth set of indicia 16 representing a plurality of activities associated with the hours of the day. For example, the indicia associated with 1:00 A.M. may be simulative of a bed, showing the user that people are typically asleep at this time. Between 8:00 A.M. and 9:00 A.M., a school bus may be represented, for example. The choice of representations is dependent upon the particular needs and desires of the user.

As noted above, the longitudinally opposed first and second ends 28, 30 are preferably joined together to form a loop (shown in FIG. 1), such that antemeridian and postmeridian hours (for example, 12:00 A.M. and 12:00 P.M.) are positioned diametrically opposite from one another. The opposed ends 28, 30 may be permanently secured to one another, or may be releasably secured to one another through the usage of any suitable releasable fastener, such as the exemplary hook and loop fasteners 26, shown in FIG. 3.

In addition to teaching the concept of elapsed time, the device 10 allows children to associate time intervals, time periods or divisions of the day with both abstract and real-life concepts. The third set of indicia 18 allow the children to easily see and understand divisions of the day, such as morning, afternoon and evening, for example, through the use of differing colors or hues associated with each time period. The fourth set of indicia 16 provide real-life or real-world simulations or representations, such as pictures of school busses, beds, and books, for example, in order to illustrate appropriate activities associated with each hour of the day. Further, in use, a child may position his or her finger on a beginning time (or point to the time) and slide his or her finger along the strip to a second time (or, alternatively, slide the strip with respect to the user's finger), in order to better visualize and understand the passage of time.

It is to be understood that the present invention is not limited to the embodiments described above, but encompasses any and all embodiments within the scope of the following claims.

I claim:

1. A device for teaching the concept of elapsed time, comprising:
an elongated strip having longitudinally opposed first and second ends, the elongated strip having opposed front and rear surfaces, a first set of graduated demarcations being formed on the front surface, a first set of indicia being formed on the front surface adjacent the first set of graduated demarcations, the first set of graduated demarcations and the first set of indicia representing hours of the day, wherein the first and second ends are joined together to form a loop.

2. The device for teaching the concept of elapsed time as recited in claim 1, further comprising a second set of graduated demarcations formed on the front surface and a second set of indicia formed on the front surface, the second set of graduated demarcations and the second set of indicia representing minutes within each hour of the day.

3. The device for teaching the concept of elapsed time as recited in claim 2, further comprising a third set of indicia formed on the front surface, the third set of indicia including a plurality of sub-sets of indicia, wherein each sub-set of indicia represents a portion of the day.

4. The device for teaching the concept of elapsed time as recited in claim 3, wherein each said sub-set of indicia has a unique hue associated therewith.

5. The device for teaching the concept of elapsed time as recited in claim 4, further comprising a fourth set of indicia formed on the front surface, the fourth set of indicia representing a plurality of activities associated with the hours of the day.

6. The device for teaching the concept of elapsed time as recited in 5, wherein the first and second sets of graduated demarcations, and the first and second sets of indicia are formed adjacent an upper edge of the front surface.

7. The device for teaching the concept of elapsed time as recited in claim 6, wherein the third set of indicia is formed on a central portion of the front surface.

8. The device for teaching the concept of elapsed time as recited in claim 7, wherein the fourth set of indicia is formed adjacent a lower edge of the front surface.

9. The device for teaching the concept of elapsed time as recited in claim 1, wherein the first and second ends are releasably joined together.

10. The device for teaching the concept of elapsed time as recited in claim 9, further comprising means for releasably securing the first end to the second end.

11. The device for teaching the concept of elapsed time as recited in claim 10, wherein the means for releasably securing the first end to the second end comprise hook and loop fasteners.

12. A method for teaching the concept of elapsed time, comprising the steps of:
providing an elongated strip having longitudinally opposed first and second ends, the elongated strip having opposed front and rear surfaces;
forming a first set of graduated demarcations on the front surface;
forming a first set of indicia on the front surface adjacent the first set of graduated demarcations, the first set of graduated demarcations and the first set of indicia representing hours of the day;
visually indicating to the user the passage of time with the first set of graduated demarcations and the first set of indicia.

13. The method for teaching the concept of elapsed time as recited in claim 12, further comprising the steps of:
forming a second set of graduated demarcations on the front surface; and
forming a second set of indicia formed on the front surface, the second set of graduated demarcations and the second set of indicia representing minutes within each hour of the day.

14. The method for teaching the concept of elapsed time as recited in claim 13, further comprising the steps of:
forming a third set of indicia on the front surface;
dividing the third set of indicia into a plurality of sub-sets of indicia, each sub-set of indicia representing a portion of the day.

15. The method for teaching the concept of elapsed time as recited in claim 14, further comprising the step of associating a unique hue with each said sub-set of indicia.

16. The method for teaching the concept of elapsed time as recited in claim 15, further comprising the step of forming a fourth set of indicia on the front surface, the fourth set of indicia representing a plurality of activities associated with the hours of the day.

17. The method for teaching the concept of elapsed time as recited in claim 12, further comprising the step of joining the first and second ends together to form a loop.

18. The method for teaching the concept of elapsed time as recited in claim 17, further comprising the step of positioning antemeridian hour indicia diametrically opposite from corresponding postmeridian hour indicia.

19. The method for teaching the concept of elapsed time as recited in claim 12, further comprising the step of releasably securing the first end to the second end.

20. The method for teaching the concept of elapsed time as recited in claim 12, further comprising the step of pointing to a first one of the first set of graduated demarcations and sliding the elongated strip with respect to the user to illustrate the passage of time.
